(19) United States
(12) Patent Application Publication
(10) Pub. No.: US 2026/0215978 A1
(43) Pub. Date: Jul. 30, 2026

(54) RESCUE APPARATUS, IN PARTICULAR A RESCUE STRETCHER

(71) Applicant: Mittelmann Sicherheitstechnik GmbH & Co. KG, Velbert (DE)

(72) Inventors: Bircihan CEYLAN, Velbert (DE); Jürgen MEYER, Velbert (DE)

(21) Appl. No.: 19/141,393

(22) PCT Filed: Dec. 19, 2023
(86) PCT No.: PCT/DE2023/100982

§ 371 Date: Jun. 20, 2025

(30) Foreign Application Priority Data
Dec. 20, 2022 (DE) 10 2022 134 089.9

(51) Int. Cl. A61G 1/044; A61G 1/01; A61G 1/013; A61G 1/04

(52) U.S. Cl. CPC A61G 1/044; A61G 1/01; A61G 1/013; A61G 1/042

(57) ABSTRACT

A rescue apparatus includes a flexible sheath which has an upper support section, for supporting a head of a person to be rescued, and a lower support section. The rescue apparatus also includes a first textile web, which is arranged between the upper support section and the lower support section and is fastened to the flexible sheath and is placed around an upper body of the person to be rescued. A support apparatus for supporting legs of the person to be rescued is displaceable along a longitudinal axis of the flexible sheath between a retracted position and an extended position with respect to the flexible sheath.

### CROSS REFERENCE TO RELATED APPLICATIONS

This application is a U.S. National Phase application under 35 U.S.C. § 371 of International Application No. PCT/DE 2023/100982, filed on Dec. 19, 2023, and claims benefit to German Patent Application No. DE 10 2022 134 089.9, filed on Dec. 20, 2022. The International Application was published in German on Jun. 27, 2024 as WO 2024/132036 A1 under PCT Article 21(2).

### FIELD

The disclosure relates to a rescue apparatus, in particular a rescue stretcher for recovering people from confined spaces, comprising a flexible sheath and a first textile web arranged above the flexible sheath.

### BACKGROUND

Rescue apparatus which are intended to ensure that the people to be rescued are positioned as stably as possible during the recover process are known from practice. Such rescue apparatuses comprise a flexible plastic base or cover, which serves to provide stable support for the person to be rescued and also performs a protective function by protecting the body of the person to be rescued from impacts during the recover. In addition, such rescue apparatuses also include a restraint system, which is formed, for example, from straps. The restraint system is used to secure the person to be rescued to the rescue apparatus and is intended in particular to prevent the person to be rescued from slipping or falling out of the rescue apparatus.

DE 20 2020 101 194 U1 shows a rescue apparatus, in particular for recovering people from confined spaces, comprising a flexible sheath, a first textile web arranged on an upper side of the flexible sheath, which sheet can be placed around the person to be rescued and a restraint system designed as a rescue strap, which system is connected to the textile web. The shown rescue apparatus supports at least the head and upper body of a person to be rescued and is designed as a short rescue stretcher.

DE 10 2019 108 336 B4 shows a system for rescuing and recovering people from an accident vehicle, comprising a first rescue plate for supporting the head and upper body of a person to be rescued and a second rescue plate for supporting the buttocks of a person to be rescued, wherein a connecting device formed by a plurality of straps is provided, with which the first rescue plate and the second rescue plate can be lifted at a common reinforced region using straps in order to recover occupants from an accident vehicle, in particular through the previously removed roof of the accident vehicle.

DE 10 2017 115 332 A1 shows a recovery apparatus for recovering people, comprising a main body, wherein the main body consists of a head part and a foot part, which are connected to one another in a hinge-like manner and can be pivoted from a folded non-use position, in which the undersides of the head part and the foot part lie against one another, into a folded-out use position.

### SUMMARY

In an embodiment, the present disclosure provides a rescue apparatus, including a flexible sheath which has an upper support section, for supporting a head of a person to be rescued, and a lower support section. A first textile web is arranged between the upper support section and the lower support section and is fastened to the flexible sheath and can be placed around an upper body of the person to be rescued, and a support apparatus for supporting legs of the person to be rescued is displaceable along a longitudinal axis of the flexible sheath between a retracted position and an extended position with respect to the flexible sheath.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a preferred exemplary embodiment of a rescue apparatus according to the invention in a rear view;

FIG. 2 is the preferred exemplary embodiment of a rescue apparatus 1 according to the disclosure from FIG. 1 in a front view;

FIG. 3 is the rescue apparatus 1 in a perspective view in a suspended state;

FIG. 4 is the rescue apparatus 1 in a front view, wherein the support apparatus 11 is retracted;

FIG. 5 is a side view of the rescue apparatus 1 from FIG. 4; and

FIG. 6 is the rescue apparatus 1 from FIG. 4 in a perspective view in a suspended state.

### DETAILED DESCRIPTION

In accordance with an embodiment, the present disclosure provides a rescue apparatus which enables a person to be rescued safely in any position and in any transport direction and which can be flexibly adapted to the body size of the person to be rescued and the recover method used.

According to one aspect, the present disclosure provides a rescue apparatus comprising a flexible sheath with an upper support section for supporting a head of a person to be rescued and a lower support section, and a first textile web arranged between the upper support section and the lower support section and fastened to the flexible sheath, which first textile web can be placed around the upper body of a person to be rescued. The rescue apparatus according to the disclosure is characterized in that a support apparatus for supporting the legs of the person to be rescued is displaceable along a longitudinal axis of the flexible sheath between a retracted position and an extended position relative to the flexible sheath. Advantageously, the length of the rescue apparatus can be adjusted and it can also be advantageously adapted to the recover method used. It may be sufficient or may even be necessary to recover the person to be rescued without supporting the legs, i.e., only the upper body and buttocks of the person to be rescued need to be supported, because the person to be rescued, for example, has to be lifted in an almost upright position from a vertically oriented opening and therefore no support of the legs may be absolutely necessary. However, it may be necessary to transport the person to be rescued in a horizontal position, wherein the entire body of the person to be rescued may be supported as far as possible. The rescue apparatus according to the disclosure thus advantageously offers the possibility of flexibly recovering a person to be rescued in any position and for any type of recovery method, in that the additional support of the legs can optionally be provided by displacing the support apparatus between the retracted position and an extended position relative to the flexible sheath.

In an expedient embodiment, it is provided that the support apparatus comprises a first support plate which, in the extended position, forms an extension of the flexible sheath for supporting the legs of the person to be rescued. In a preferred development, at least one second textile web is arranged laterally on the first support plate, wherein the second textile web can be placed around the legs of the person to be rescued. Advantageously, this ensures that the legs of the person to be rescued remain safely on the first support plate at all times, since the legs are surrounded by the second textile web, at least laterally and from above.

In an expedient development, a third textile web is arranged laterally on the first support plate, wherein the third textile web is arranged opposite the second textile web. Particularly preferably, the third textile web is arranged mirror-symmetrically to the second textile web. Advantageously, the legs of the person to be rescued can be protected or secured in the rescue apparatus by the textile webs by folding over the second textile web and finally by folding over the third textile web. The second textile web and the third textile web can expediently be connected to one another via a closure device, in particular a hook-and-loop fastener, wherein the closure device is arranged in an overlap region of the second textile web and the third textile web in the closed state.

Particularly preferably, the second textile web has a first wing and a second wing, which are separated by a lateral recess. Advantageously, the lateral recess provides the possibility of passing a carrying strap through the lateral recess, which can serve on one side to support the first support plate against the flexible sheath and on the other side to suspend the rescue apparatus from an external fixed point. Analogously, the third textile web also has a first wing and a second wing, which are separated by a lateral recess.

In an advantageous development, the first support plate is designed to be flexible. In particular, the first support plate is advantageously made of plastic. It is particularly expedient if both the flexible sheath and the first support plate are made of the same material, in particular plastic. The plastic is particularly advantageously designed as a thermoplastic. Particularly preferably, the plastic is designed as polyethylene terephthalate (PET). Advantageously, the flexible sheath or the first support plate can be pre-formed as desired.

Preferably, the flexible sheath has an underside that is at least partially convex. Particularly advantageously, the flexible sheath is at least partially trough-shaped, so that the person to be rescued can be supported by laterally formed support sections in the flexible sheath. Particularly preferably, the laterally formed support sections can be bent upwards by means of traction means, thus providing lateral support for the person to be rescued. In an expedient development, the traction means are designed as tensioning straps which can be connected to one another via buckles. Advantageously, the tensioning straps also serve to secure the person to be rescued, whose upper body is surrounded by the first textile web.

The first support plate preferably has a rectangular shape and is flat. Advantageously, the first support plate is designed to be space-saving and cost-effective, since in particular a lateral fixation of the legs is already provided by the second or third textile web and thus no special pre-forming of the first support plate may be required.

In a particularly preferred embodiment, it is provided that a second support plate is coupled to the first support plate and can be used as an extension of the first support plate. In an expedient further development, the second support plate is designed to be pivotable relative to the first support plate via a hinge between a folded-in position and a folded-out position. Advantageously, the second support plate can be folded in to save space when not needed and can also be easily folded out, with the swivel angle preferably being a maximum of 180°.

Advantageously, the second support plate rests on the underside of the first support plate in the folded-in position, so that the second support plate can be folded downwards and held in this position. Expediently, holding means are provided on the second support plate and hold the second support plate in the folded-out position. Particularly preferably, the holding means are designed as hook-and-loop strips. Advantageously, the hook-and-loop strips can be easily attached to the second or third textile web.

In an advantageous embodiment, at least one first tensioning strap is fastened with a first end to the support apparatus to limit a displacement of the support apparatus in the extension direction. Expediently, the first tensioning strap is attached at least indirectly to the first textile web by a second end. Further preferably, the first tensioning strap is attached with a first end to an underside of the first support plate. The first tensioning strap is advantageously adjustable in length so that, if needed, support apparatuses of different lengths can be used in the rescue apparatus and, in addition, inelastic deformations within the tensioning strap that occur over time can be compensated for at any time by adjusting the length.

The first tensioning strap ensures that the support apparatus cannot be displaced further in the extension direction and is also pre-tensioned towards the flexible sheath. Particularly preferably, a second tensioning strap, which is fastened with a first end to the support apparatus and with a second end at least indirectly to the first textile web, is provided. Advantageously, the first support plate can be preloaded more evenly and more reliably prevented from further displacement in the extension direction.

Particularly preferably, at least one first carrying strap is connected to a first side of the first textile web and a second carrying strap is connected to a second side of the first textile web opposite the first side. Expediently, a pair of first carrying straps and a pair of second carrying straps are provided, each of which is connected to a first fastening element and a second fastening element for coupling to an external suspension point. The carrying straps are used to transport the person to be rescued, suspended, in either horizontal, vertical or inclined position. This type of transport is needed, for example, in a rescue from a cavity through a small access opening at the top, wherein the access opening is so small that it only allows safe transport of the person to be rescued in at least a partially vertical position.

Particularly preferably, a third carrying strap is attached with a first end to an upper side of the first support plate. In an expedient embodiment, a third fastening element for coupling to an external suspension point is arranged at a second end of the third carrying strap opposite the first end. In an expedient development, the third fastening element is designed as a carabiner hook or carabiner ring. Advantageously, by suspending the rescue apparatus from an external suspension point while simultaneously using the three carrying straps, support of the first support plate is also provided by the third carrying strap.

In an advantageous development, it is provided that a back support is arranged on the first textile web, wherein the back support is detachably coupled to the first textile web via at least one first fastening means. Preferably, the first fastening means is designed as an elastic band which runs transversely to a longitudinal direction of the back support over the back support and is sewn to the first textile web. Expediently, at least one second fastening means, which is preferably also designed as an elastic band, is provided. Advantageously, the back support can be easily removed from the rescue apparatus and the back support can also be lifted upwards against the pretension of the elastic band.

Particularly preferably, the support apparatus is arranged in the retracted position between the first textile web and the back support. Advantageously, a securing element coupled to the first textile web, which is provided for axially securing the support apparatus below the back support, is also provided. The securing element is preferably designed as a hook-and-loop strip so that the securing can be carried out particularly quickly and easily and is also easy to remove. The support apparatus can be advantageously stored below the back support in a particularly space-saving manner, wherein the basic functionality of the rescue stretcher, which is then designed as a short stretcher, is not impaired.

Another advantage is that the support apparatus can rest against the back support at the front in the extended position. Particularly preferably, in an upper portion facing the back support, the support apparatus has a hook-and-loop strip which can be connected to the back support. For this purpose, the back support particularly preferably comprises a textile cover in which a rigid support part is inserted. The support part is preferably designed as a board. Particularly preferably, the support part is formed by an upper metal layer, a lower metal layer and a grid structure arranged between the metal layers.

In a particularly preferred development, a restraint system for securing a person to be rescued is connected to the textile web. The restraint system is advantageously designed as a rescue strap. The restraint system includes at least one chest strap and a pair of leg straps. Expediently, the system also includes a pair of shoulder straps.

In a preferred embodiment, it is provided that a caudal pull loop and/or a cranial pull loop is connected to the restraint system. The caudal or cranial pull loop advantageously makes it possible to pull the person to be rescued in a caudal or cranial direction out of a horizontally oriented cavity without having to enter the corresponding cavity itself. Often, injured people are found in cavities that are at least not accessible to several people at the same time, so that only one person can enter the cavity to transfer the person to be rescued onto the rescue apparatus and a second person standing outside the cavity can pull the person to be rescued out of the cavity in a horizontal position using the caudal or cranial pull loop.

The disclosure is explained in more detail below with reference to the accompanying drawings using a preferred embodiment.

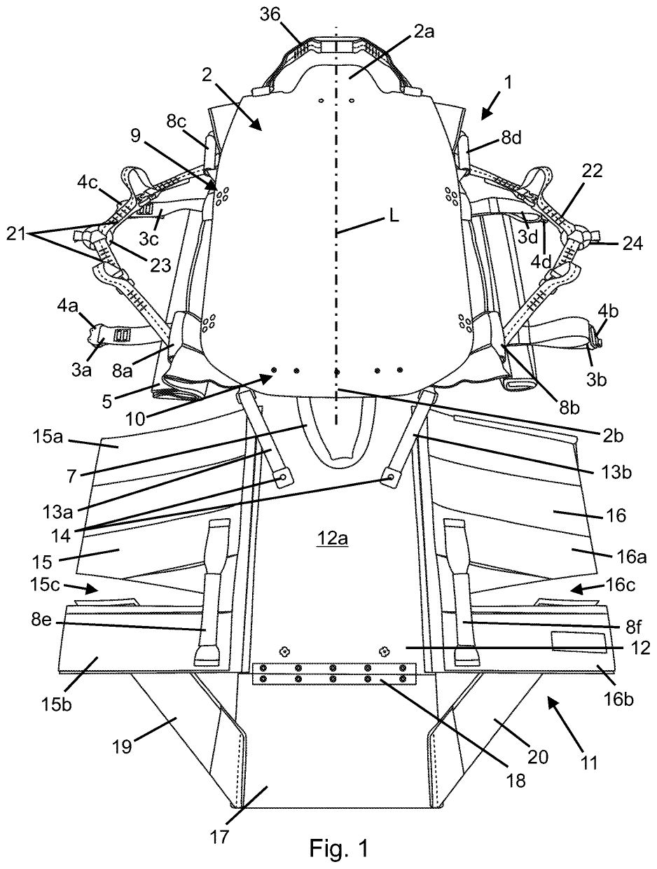

FIG. 1 shows a preferred exemplary embodiment of a rescue apparatus 1 according to the disclosure in a rear view in which the underside of the rescue apparatus 1 can be seen. The rescue apparatus 1 comprises a flexible sheath 2 extending longitudinally along a longitudinal axis L with an upper support section 2a, which is provided at an upper end and which is intended to support a head of the person to be rescued. The flexible sheath 2 is made of a plastic, preferably PET, so that the weight of the rescue apparatus 1 designed as a rescue stretcher remains as low as possible and at the same time the person to be rescued is protected from injuries caused by sharp edges or the like located below or to the side of the person to be rescued.

Furthermore, the flexible sheath 2 is designed to be flexible, particularly laterally along its longitudinal axis L, so that the flexible sheath 2 can be bent upwards laterally by means of tensioning straps 3a, 3b, 3c, 3d attached to the sides, and thus protection of the shoulders and arms of the person to be rescued can also be easily achieved. In the exemplary embodiment shown here, the opposing tensioning straps 3a, 3b and 3c, 3d are connected to each other via buckles 4a, 4b, 4c and 4d. This advantageously allows for particularly simple and quick tensioning of the tensioning straps 3a-3d. This is particularly relevant in cases where the person to be rescued has to be pulled over a rough or otherwise sharp-edged surface, which is often the case in confined spaces such as the engine rooms of a wind turbine or in cave systems.

The rescue apparatus 1 further comprises a first textile web 5, which is fastened to the upper side of the flexible sheath 2, which is hidden here. The first textile web 5 is placed around the person to be rescued during a recovery and closed by means of a hook-and-loop fastener so that on the one hand the upper body of the person is protectively covered and at the same time additional lateral fixation is provided.

In the area of the upper support section 2a, a cranial pull loop, hidden in FIG. 1, is arranged on the flexible sheath 2. Opposite the cranial pull loop there is a caudal pull loop 7. The pull loops make it possible to pull the person to be rescued through narrow access points where carrying the person to be rescued is not possible due to a lack of space. Furthermore, the rescue apparatus 1 comprises two carrying handles 8a, 8b, 8c, 8d arranged laterally on the first textile web 5, so that the person to be rescued can be carried in the rescue apparatus 1. Accordingly, the rescue apparatus 1 can be used as a normal rescue stretcher to carry the person to be rescued to a transfer point and the like.

In the exemplary embodiment shown here, the first textile web 5 is securely connected to the flexible sheath 2 via four rivet connections 9 at four different points, which form the corner points of a rectangle. Screw connections 10, which serve to secure the first textile web 5 in the area of the caudal pull loop 7, can also be seen on a lower support section 2b of the flexible sheath 2 opposite the upper support section 2a.

Below the lower support section 2b, an additional support apparatus 11 can be seen, which in the state of the rescue apparatus shown in FIG. 1 has been extended along the longitudinal axis L of the flexible sheath 2 and thus advantageously makes the rescue apparatus 1 usable as a long stretcher in which the legs of the person to be rescued are completely supported by the support apparatus 11.

The support apparatus 11 comprises a first support plate 12, which is connected to two length-adjustable tensioning straps 13a, 13b to secure it in the extension direction. For this purpose, a first end of each of the tensioning straps 13a, 13b is connected via a screw connection 14 to the underside 12a of the first support plate 12 shown here. The second ends of the tensioning straps 13a, 13b, not shown here, are in turn connected at least indirectly to the first textile web 5. Advantageously, it is accordingly ensured that the entire support apparatus 11 cannot be displaced further in the extension direction relative to the flexible casing 2 when the rescue apparatus 1 is used with the support apparatus 11 extended.

A second textile web 15 and a third textile web 16 are arranged to the side of the first support plate 12 and are placed around the legs of the person to be rescued and can be connected to each other via a hook-and-loop fastener. A second support plate 17, which can optionally be folded out relative to the first support plate 12 via a hinge 18 and thus provides an additional extension of the support apparatus 11, is arranged at a lower end of the first support plate 12.

The second support plate 17 rests in a folded-in state on the underside 12a of the first support plate 12 and is folded as may be required by approximately 180° by means of the hinge 18, the axis of rotation of which runs perpendicular to a longitudinal direction of the first support plate 12, until the second support plate 17 forms an extension of the first support plate 12, as shown here in FIG. 1.

A first hook-and-loop strip 19 and a second hook-and-loop strip 20 are attached to the side of the second support plate 17, wherein the hook-and-loop strips 19, 20 are connected to an upper side of the second textile web 15 or the third textile web 16, which is not visible here, so that when the second textile web 15 or the third textile web 16 is folded around the legs of the person to be rescued and the two textile webs 15, 16 are then connected, it is ensured that the second support plate 17 is pre-tensioned into the folded-out position by the second and third textile webs 15, 16.

The second textile web 15 is advantageously divided into a first wing 15a and a second wing 15b, wherein the first wing 15a is provided substantially for fixing the legs of the person to be rescued and the second wing 15b is provided for fixing the first hook-and-loop strip 19. The first wing 15a and the second wing 15b are separated by a first lateral recess 15c. Analogously, the third textile web 16 is divided into a first wing 16a and a second wing 16b, wherein here too the first wing 16a is provided for fixing the legs of the person to be rescued and the second wing 16b is provided for fixing the second hook-and-loop strip 20. The first wing 16a and the second wing 16b are separated by a second lateral recess 16c.

A further carrying handle 8e, 8f is fastened to the first textile web 15 and the second textile web 16, respectively, between the first wing 15a and the second wing 15b of the second textile web 15 and between the first wing 16a and the second wing 16b of the third textile web 16. The two additional carrying handles 8e, 8f advantageously make it possible to move the person on the rescue apparatus 1, which is now designed as a long stretcher. The first support plate 12 and the second support plate 17 are advantageously made of the same material as the flexible sheath 2, although the first support plate 12 and the second support plate 17 are flat in contrast to the flexible sheath 2 and the flexible sheath 2 is curved in a trough shape.

In addition to the carrying handles 8a-f, the rescue apparatus 1 comprises first carrying straps 21 and second carrying straps 22 arranged laterally on the first textile web 5, which make it possible to suspend the rescue apparatus 1 from a fixing point, which is provided, for example, by a tripod, and, if needed, to lower it via an intermediate abseiling device or to lift it upwards via a lifting device. The first carrying straps 21 are coupled to a first carabiner ring 23 and the second carrying straps 22 to a second carabiner ring 24, which in turn can be connected to a suspension point. The first and second carrying straps 21, 22 are each designed to be adjustable in length so that the rescue apparatus 1 can be suspended at different angles.

Furthermore, the rescue apparatus 1 comprises a suspension loop 36 arranged above the head region, on which the rescue apparatus 1 can be suspended, thereby enabling recovery in a completely vertical position. This type of recovery is particularly advantageous when the person to be rescued has to be lifted out of a narrow vertical space and the opening or the overall diameter of the space is not large enough to pull the person out in a horizontal or inclined position.

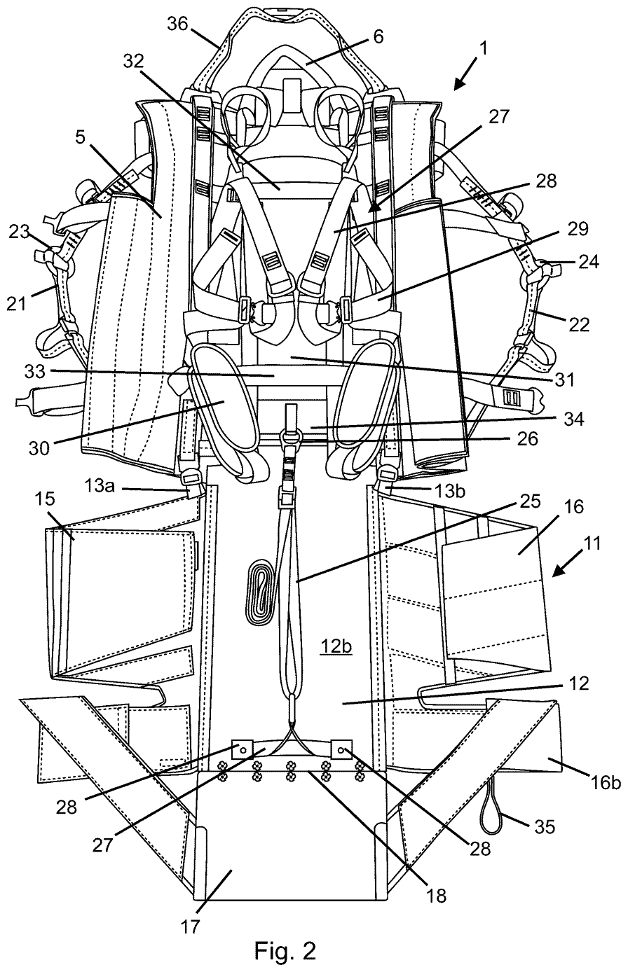

FIG. 2 shows the preferred exemplary embodiment of a rescue apparatus 1 according to the disclosure from FIG. 1 in a front view, in which the upper side of the rescue apparatus 1 facing the person to be rescued can be seen. In this view it can be seen that, in addition to the first carrying straps 21 and the second carrying straps 22, the rescue apparatus 1 has a third carrying strap 25, wherein the third carrying strap 25 is connected with a first end to a lower portion of the upper side 12b of the first support plate 12 of the support apparatus 11 and a third carabiner ring 26 is fastened to a second end of the third carrying strap 25, which third carabiner ring can be connected together with the first carabiner ring 23 of the first carrying straps 21 and the second carabiner ring 24 of the second carrying straps 22 to a common suspension point. The end of the third carrying strap 25 opposite the third carabiner ring 26 is connected to the upper side 12b of the first support plate 12 via a fastening strap 27 connected to the first support plate 12. The fastening strap 27 is secured on both sides to the first support plate 12 via rivet connections 28.

Advantageously, the third carrying strap 25 provides horizontal support of the first support plate 12 downwards and, at the same time, the tensioning straps 13a, 13b provide horizontal support of the first support plate 12 upwards. Advantageously, the interaction of the third carrying strap 25 and the two tensioning straps 13a, 13b ensures that the support apparatus 11 or the first support plate 12 always encloses a certain angular range relative to the flexible sheath 2 and does not tilt upwards or downwards.

Furthermore, it can be seen that a rescue strap 27 is attached to the first textile web 5 by sewing. The person to be rescued is thereby held securely in the rescue strap 27, so that regardless of the spatial position of the rescue apparatus 1, it is always ensured that the person to be rescued cannot fall out of the rescue apparatus 1. The rescue strap 27 comprises a pair of shoulder straps 28, a chest strap 29 and a pair of leg straps 30, all of which can be opened and closed as usual by buckles and are also partially adjustable in length. This advantageously allows for quick and reliable securing of the person to be rescued in the rescue apparatus 1.

Furthermore, a longitudinally extending back support 31 is provided, which rests centrally on the first textile web 5 and is secured against slipping relative to the first textile web 5 by means of an upper elastic band 32 and a lower elastic band 33. The back support 31 comprises a cover made of a textile and a support part arranged in the cover, which support part is formed preferably by an upper metal layer, a lower metal layer and a grid structure arranged between the metal layers. Furthermore, a rubber surface is provided on the top side of the upper metal layer. The grid structure ensures that the board absorbs the weight of the person to be rescued with some resilience, but always provides stable support for the back of the person to be rescued, which is particularly crucial in the case of existing spinal injuries.

The end of the first support plate 12 facing the back support 31 is connected to the back support 31 via a hook-and-loop strip 34 which is fastened to the first support plate 12, so that the first support plate 12 adjoins the back support 31 at the end and is thereby secured against displacement relative to the textile 5 in the retraction direction along the longitudinal direction of the rescue apparatus 1. The tensioning straps 13a, 13b also tension the first support plate 12 against the back support 31.

In the exemplary embodiment of the rescue apparatus 1 shown here, the first support plate 12 together with the second support plate 17, which can be folded out via the hinge 18, and the first textile web 15 and the second textile web 16 can be pushed under the back support 31, so that the rescue apparatus 1 can be quickly and easily converted from a long stretcher into a short stretcher. In order to pull out the support apparatus 11 again, a pull loop 35 is attached to the second wing 16b of the second textile web 16, which can be grasped by hand even when the support apparatus 11 is completely displaced under the back support 31 and the short stretcher can be converted back into a long stretcher. Furthermore, the cranial loop 6 can also be seen in FIG. 2.

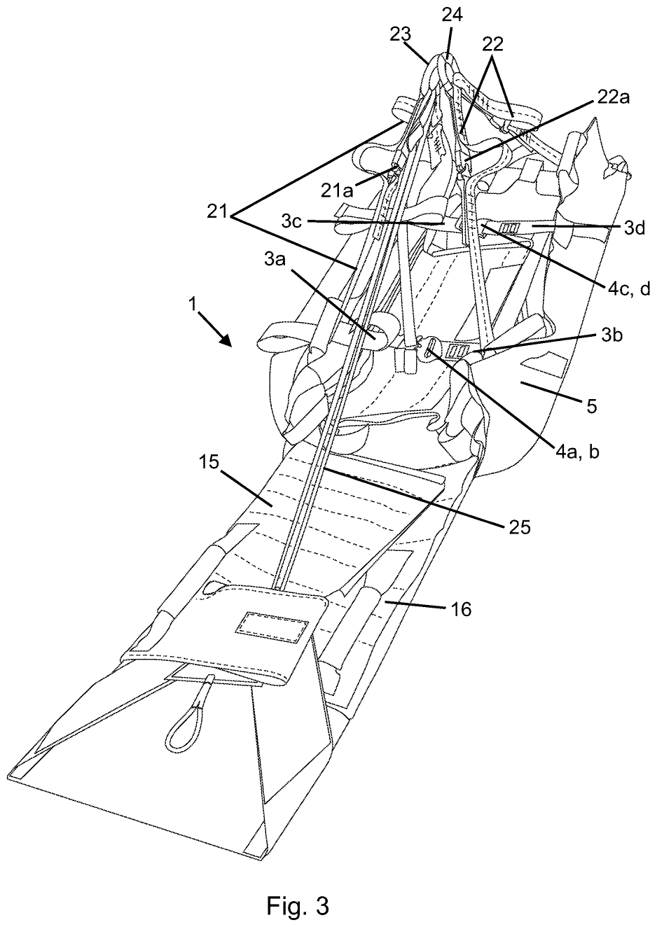

FIG. 3 shows the rescue apparatus 1 in a perspective view in a suspended state. The rescue apparatus 1 is suspended via the first and second carrying straps 21, 22 and the third carrying strap 25 from a fixed point (not shown here), for example a carabiner hook, wherein the first textile web 15 and the second textile web 16, due to their division into first wings 15a, 16a and second wings 15b, 16b, have a gap formed by the two lateral recesses 15c, 16c (see FIG. 1), through which the third carrying strap 25 is passed unhindered. It can also be seen that the first carrying straps 21 and the second carrying straps 22 are adjustable at least between two lengths, which can be selected by opening and closing clip fasteners 21a and 22a, respectively.

In the state shown in FIG. 3, the second textile web 15 and the third textile web 16 are also placed on top of each other and connected to each other via a hook-and-loop fastener, so that the legs of the person to be rescued are protectively surrounded by the second textile web 15 and the third textile web 16. Furthermore, it can be seen that the tensioning straps 13a, 13b are connected to each other via the buckles 4a-d, so that the first textile web 5 and the person inside it are also secured.

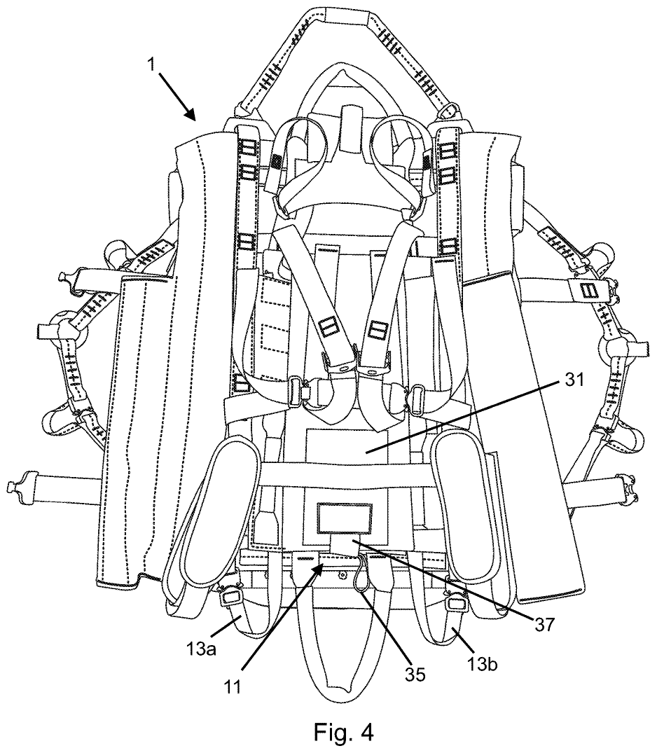

FIG. 4 shows the rescue apparatus 1 in a front view, wherein the support apparatus 11 is retracted. In this state, the support apparatus 11 has been pushed under the back support 31, so that the rescue apparatus 1 can now be used as a short rescue stretcher. In order to pull out the support apparatus 11, a securing element 37, which in the exemplary embodiment shown here is designed as a hook-and-loop strip, may first be released and then the support apparatus 11 can be pulled out by pulling on the pull loop 35 and made ready for use by tightening the two tensioning straps 13a, 13b.

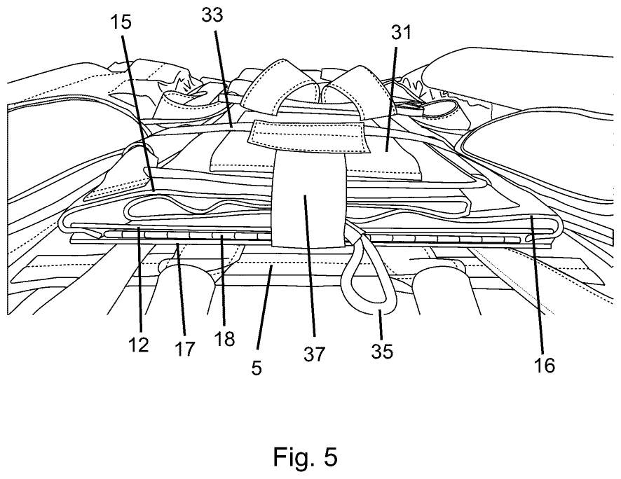

FIG. 5 shows a side view of the rescue apparatus 1 from FIG. 4. In this view, the support apparatus 11 arranged between the back support 31 and the first textile web 5 can be seen in the retraction direction, wherein the support apparatus 11 is secured against unintentional extension or slipping out by the securing element 37 designed as a hook-and-loop fastener, which is connected to the textile upper side of the back support 31.

In the retracted state, the second textile web 15 is folded over the third textile web 16, so that the first support plate 12, the second support plate 17, which is pivotably coupled to the first support plate 12 via the hinge 18, is arranged in a space-saving manner between the first textile web 5 and the back support 31. This is possible because the back support 31 is coupled to the first textile web 5 only via the elastic bands, of which only the lower elastic band 33 can be seen in FIG. 5.

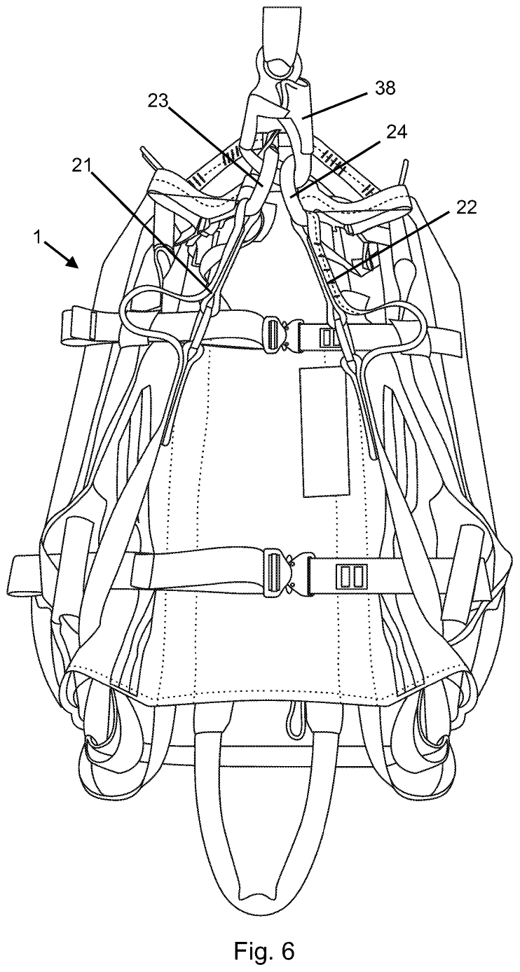

FIG. 6 shows the rescue apparatus 1 from FIG. 4 in a perspective view in a suspended state. If the rescue apparatus 1 is designed as a short rescue stretcher in which the support apparatus 11 is retracted, the rescue apparatus 1 is suspended only via the first carrying straps 21 and second carrying straps 22 via the first carabiner ring 23 and second carabiner ring 24 attached thereto on a suspension 38 designed as a carabiner hook.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A rescue apparatus, comprising
a flexible sheath which has an upper support section, for supporting a head of a person to be rescued, and a lower support section,
a first textile web, which is arranged between the upper support section and the lower support section, and is fastened to the flexible sheath and is placed around an upper body of the person to be rescued,
wherein
a support apparatus for supporting legs of the person to be rescued is displaceable along a longitudinal axis of the flexible sheath between a retracted position and an extended position with respect to the flexible sheath.

2. The rescue apparatus according to claim 1, wherein the support apparatus comprises a first support plate which, in the extended position, forms an extension of the flexible sheath for supporting the legs of the person to be rescued, wherein the first support plate is flexible and comprises of plastic.

3.-9. (canceled)

10. The rescue apparatus according to claim 2, wherein the flexible sheath and the first support plate are made of a same plastic.

11. The rescue apparatus according to claim 2, wherein the plastic is designed as a thermoplastic.

12. The rescue apparatus according to claim 2, wherein the plastic is formed as polyethylene terephthalate (PET).

13. The rescue apparatus according to claim 2, wherein the first support plate has a rectangular shape and is flat.

14. The rescue apparatus according to claim 2, wherein a second support plate is coupled to the first support plate and can be used as an extension of the first support plate.

15. The rescue apparatus according to claim 14, wherein the second support plate is pivotable relative to the first support plate via a hinge between a folded-in position and a folded-out position.

16. The rescue apparatus according to claim 15, wherein the second support plate rests on an underside of the first support plate in the folded-in position, so that the second support plate can be folded downwards and held in this position.

17. The rescue apparatus according to claim 16, wherein holding means are provided on the second support plate and hold the second support plate in the folded-out position.

18. The rescue apparatus according to claim 17, wherein the holding means are designed as hook-and-loop strips.

19. The rescue apparatus according to claim 16 wherein at least one first tensioning strap is fastened with a first end to the support apparatus for limiting a displacement of the support apparatus in an extension direction, wherein the at least one first tensioning strap is fastened at least indirectly to the first textile web with a second end is fastened to an underside of the support plate.

20.-27. (canceled)

28. The rescue apparatus according to claim 1 wherein a back support is arranged on the first textile web, wherein the back support is detachably coupled to the first textile web via at least one first fastening means.

29. The rescue apparatus according to claim 28, wherein the first fastening means is designed as an elastic band which runs transversely to a longitudinal direction of the back support over the back support and is sewn to the first textile web.

30. The rescue apparatus according to claim 28, wherein the support apparatus is arranged in the retracted position between the first textile web and the back support.

31. The rescue apparatus according to claim 30, wherein a securing element coupled to the first textile web is provided and is provided for axially securing the support apparatus below the back support.

32. The rescue apparatus according to claim 31, wherein the securing element is designed as a hook-and-loop strip.

33. The rescue apparatus according to claim 28, wherein the back support comprises a textile cover in which a rigid support part is inserted.

34. The rescue apparatus according to claim 33, wherein the rigid support part is designed as a board.

35. The rescue apparatus according to claim 33, wherein the rigid support part is formed by an upper metal layer, a lower metal layer and a grid structure arranged between the upper metal layer and the lower metal layer.
